(19) United States
(12) Patent Application Publication
(10) Pub. No.: US 2024/0248816 A1
(43) Pub. Date: Jul. 25, 2024

(54) CONTINUOUS DATA PROTECTION AGAINST RANSOMWARE FOR VIRTUAL VOLUMES

(71) Applicant: VMware, Inc., Palo Alto, CA (US)

(72) Inventors: Ashutosh Saraswat, Bangalore (IN); Indranil Bhattacharya, Bangalore (IN); Thorbjoern Donbaek Jensen, Hoejbjerg (DK)

(21) Appl. No.: 18/201,139

(22) Filed: May 23, 2023

(30) Foreign Application Priority Data
Jan. 19, 2023 (IN) 202341003819

(51) Int. Cl. G06F 11/14; G06F 9/455; G06F 21/78

(52) U.S. Cl. CPC G06F 11/1469; G06F 9/45558; G06F 21/78; G06F 2009/45587

(57) ABSTRACT

The disclosure provides a method for virtual volume (vvol) recovery. The method generally includes determining to initiate recovery of a compromised vvol associated with a virtual machine (VM), transmitting a query requesting a list of snapshots previously captured for the compromised vvol, receiving the list of the snapshots previously captured for the compromised vvol and information about one or more snapshots in the list of snapshots, wherein for each of the snapshots, the information comprises an indication of at least one change between the snapshot and a previous snapshot, determining a recovery point snapshot among snapshots in the list of the snapshots based, at least in part, on the information about the one or more snapshots, creating a clone of the recovery point snapshot to generate a recovered virtual volume, creating a virtual disk from the recovered virtual volume, and attaching the virtual disk to the VM.

### CROSS-REFERENCE TO RELATED APPLICATIONS

Benefit is claimed under 35 U.S.C. 119(a)-(d) to Foreign Application Serial No. 202341003819 filed in India entitled “CONTINUOUS DATA PROTECTION AGAINST RANSOMWARE FOR VIRTUAL VOLUMES”, on Jan. 19, 2023 by VMware, Inc., which is herein incorporated in its entirety by reference for all purposes.

### BACKGROUND

As computer systems scale to enterprise levels, particularly in the context of supporting large-scale data centers, the underlying data storage systems frequently employ a storage area network (SAN) or network attached storage (NAS). SAN or NAS provides a number of technical capabilities and operational benefits, including virtualization of data storage devices, redundancy of physical devices with transparent fault-tolerant fail-over and fail-safe controls, geographically distributed and replicated storage, and centralized oversight and storage configuration management decoupled from client-centric computer systems management.

Architecturally, the storage devices in a SAN storage system include storage arrays, also referred to as disk arrays, which are dedicated storage hardware that contain multiple disk drives. The storage arrays are typically connected to network switches (e.g., Fibre Channel switches, etc.) which are then connected to servers or “hosts” (e.g., having virtual machine (VMs) running thereon) that require access to the data in the storage arrays.

Conventional storage arrays store persistent data in coarse storage containers such as logical unit numbers (LUNs) or file system volumes. This means that if a conventional storage array needs to apply service policies or management operations to its stored data, the array can only do so on a per-LUN/file system volume basis because the LUN/file system volume is the smallest logical unit of storage that is understood by the array. This limitation can be problematic in virtualized deployments where there is a many-to-one mapping between storage clients, such as a VMs, and LUNs/file system volumes. In these deployments, each VM may require a certain quality of service (QOS) and/or storage management operations that are specific to its data. However, because the data for multiple VMs is contained in one LUN/file system volume, the storage array cannot distinguish one VM from another and thus cannot autonomously apply storage policies/operations on a per-VM basis.

To address the foregoing, a framework has been developed (referred to herein as the “virtual volume framework”) that enables storage arrays to understand and manage data in the form of more granular logical storage objects known as virtual volumes (also referred to herein as “logical storage volumes”). Virtual volumes are encapsulations of virtual machine files, virtual disks, and/or their derivatives. Unlike LUNs and file system volumes, each virtual volume is configured to hold the persistent data (e.g., virtual disk data, VM configuration data, etc.) for a particular VM. In other words, each virtual volume may include a virtual disk of a particular VM, and the particular VM may have multiple virtual volumes (e.g., where the particular VM has multiple virtual disks). With this framework, the platform components in a virtualized deployment can inform a virtual volume-enabled storage array of service policies or management operations that are needed with respect to specific virtual volumes (and thus, specific VMs), thereby providing more granularity to the system. The virtual volume-enabled storage array can then autonomously apply the policies or operations to the specified virtual volumes. Additional details regarding virtual volumes and the virtual volume framework are provided in U.S. Pat. No. 8,775,773, issued Jul. 8, 2014, and entitled “Object Storage System,” the entire contents of which are incorporated by reference herein, and U.S. Pat. No. 8,775,774, issued Jul. 8, 2014, and entitled “Management System and Methods for Object Storage System,” the entire contents of which are incorporated by reference herein.

The virtual volume framework may enable snapshot and/or cloning features for data protection purposes (as well as for backup and/or archival purposes). Some snapshot features provide the ability to capture a point-in-time state and data of a VM/LUN to not only allow data to be recovered in the event of an attack but restored to known working points. Cloning features provide the ability to create a consistent copy of snapshots created for VMs/LUNs and store such copies at a site different from where the original snapshots are stored, should the site where the original snapshots are stored become susceptible to attack. In other words, some implementations may create snapshots and clones at the VM/LUN level. However, in some cases, such operations may be desired at a finer granularity (e.g., at the virtual volume level).

For example, a VM may have ten virtual disks, encapsulated in ten virtual volumes associated with the VM. Instead of creating a snapshot for each of the ten virtual volumes (e.g., ten virtual disks), a single snapshot may be taken to capture the state of the data of each of the VM's ten virtual volumes at different points in time. Accordingly, when one of the ten virtual disk files becomes infected, recovery of the virtual disk file using the snapshot may also unnecessarily require recovery of the remaining nine disk files for the VM. As such, time and/or resources required for such recovery may be increased.

Further, creation of VM-level snapshots may unnecessarily waste resources where a customer desires to create snapshots for a few of the VM's virtual volumes (e.g., virtual disks), but not all virtual volumes associated with the VM. For example, a customer may desire to only provide protection for data stored on two of the ten virtual volumes associated with the VM, using the previous example (e.g., the customer may not be concerned with the other eight virtual volumes/virtual disks). However, because only VM-level snapshot creation functionality is provided, snapshots may be continuously created for all ten virtual volumes of the VM, thereby increasing resource usage. This problem is further compounded where a customer has a multitude of VMs, each having multiple virtual volumes/virtual disks, and only one or a few of the virtual volumes/virtual disks are of concern to the customer.

In the event of a disaster, such as a malware attack on a virtual disk file of the VM, snapshots created for the VM may be used to restore the file to a point in time prior to the infection. Recovery, however, is limited at a high granularity given snapshots are not available for individual virtual volumes. Thus, the risk for data loss during recovery is greater.

Additionally, some implementations may generally store snapshots created for a VM on a cloud or on a site (e.g., a secondary site) different from where the virtual volumes associated with the VM are stored (e.g., a primary site). As such, the recovery workflow requires movement of data from the secondary site to the primary site before restore processes can be performed and operations can be resumed. As such, recovery operations incur the cost of data movement both in terms of time and money.

It should be noted that the information included in the Background section herein is simply meant to provide a reference for the discussion of certain embodiments in the Detailed Description. None of the information included in this Background should be considered as an admission of prior art.

### SUMMARY

One or more embodiments provide a method for virtual volume recovery. The method generally includes determining, by a virtualization manager, to initiate recovery of a compromised virtual volume associated with a virtual machine. The method generally includes transmitting, by the virtualization manager to a storage array managing the compromised virtual volume, a query requesting a list of snapshots previously captured by the storage array for the compromised virtual volume. The method generally includes, in response to transmitting the query, receiving, by the virtualization manager from the storage array, the list of the snapshots previously captured by the storage array for the compromised virtual volume and information about one or more snapshots in the list of snapshots, wherein for each of the snapshots, the information comprises an indication of at least one change between the snapshot and a previous snapshot. The method generally includes determining, by the virtualization manager, a recovery point snapshot among snapshots in the list of the snapshots based, at least in part, on the information about the one or more snapshots. The method generally includes creating, by the storage array, a clone of the recovery point snapshot to generate a recovered virtual volume to replace the compromised virtual volume. The method generally includes creating, by the virtualization manager, a virtual disk from the recovered virtual volume. The method generally includes attaching, by the virtualization manager, the virtual disk to the virtual machine.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates an example network environment in which embodiments described herein may be implemented.

FIG. 2A is a flow diagram illustrating example operations for generating and maintaining logical storage volume snapshots, according to an example embodiment of the present disclosure.

FIG. 2B is a flow diagram illustrating example operations for ransomware threat detection of logical storage volumes, according to an example embodiment of the present disclosure.

FIG. 2C is a flow diagram illustrating example operations for recovery of a compromised logical storage volume, according to an example embodiment of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Data protection techniques, such as ransomware threat detection and backup/recovery in the event of a ransomware attack, provided at a virtual volume granularity are described herein. Ransomware is a type of malware (e.g., malicious software that uses malicious code to exploit vulnerabilities or deceive a user) that infects a computing device, encrypts files and blocks access to them typically until a digital payment is made. As such, early detection of ransomware is critical for effectively defending against this threat and minimizing damage to an organization. Further, a robust backup and recovery strategy, as part of an overall ransomware protection strategy, can help to protect such files and avoid paying ransom by using backup solutions that are outside the reach of attackers. Backup and recovery techniques may help to quickly and efficiently recover organization-critical data and resume normal operations.

To provide ransomware threat detection for individual virtual volumes, artificial intelligence (AI)/machine learning (ML) solutions may be implemented at a storage array that is used to manage such virtual volumes. In particular, the AI/ML solutions described herein may be configured to collect and analyze metrics about individual virtual volumes to predict whether one or more of the virtual volumes are under attack. Such metrics may include I/O patterns (e.g., patterns of reads and writes), I/O operations per second (IOPS), data deduplication ratios, data compression ratios, and/or the like. For example, AI/ML-driven threat detection solutions may be used to determine and analyze a data deduplication ratio of a virtual disk file (e.g., for a particular virtual volume). Data deduplication is the process of removing redundant data, and a data deduplication ratio represents an amount of data stored on a virtual disk file after deduplication operations are performed for data on the disk A decreasing data deduplication ratio (e.g., indicating that redundant data is being written to the virtual disk file less often over time) may indicate that the virtual disk file is at risk of being encrypted by a malicious attacker (e.g., a ransomware attack). Thus, by analyzing at least the deduplication rate for the virtual disk file, the storage array may identify that the virtual volume, for the virtual disk file, is under attack and take steps to further protect the data should the attack be successful (e.g., requiring recovery of the virtual disk file from snapshot previously created for the virtual disk file) In certain embodiments, AI/ML solutions implemented at the storage array for ransomware threat detection may be used in combination with ransomware threat detection operations performed at a host (e.g., a hypervisor of the host) where the VM is running.

To protect data stored at a virtual volume that is determined to likely be under attack, embodiments described herein propose techniques for automatically increasing the frequency at which snapshots are created for the virtual volume. In certain embodiments, in addition to or alternative to increasing the snapshot frequency, the storage array may automatically increase an amount of time that snapshots, generated for the virtual volume, are retained by the storage array. In certain embodiments, in addition to or alternative to increasing the snapshot frequency and/or the lifetime of the snapshot, the storage array may determine to clone the snapshots generated for the virtual volume and store the generated snapshots at a secondary site. One or more of these techniques may help to (1) preserve critical data stored at the virtual volume from being encrypted and (2) increase a number of snapshots generated for the virtual volume. Thus, should recovery of the VM and its virtual volume be required, an appropriate recovery point may be selected from the multiple snapshots, as opposed to selecting from only a few snapshots. A larger number of snapshots may provide a larger pool of restore points for a customer to choose from, as well as provide, a smaller time period between, for example, a snapshot captured when the virtual volume was healthy and a snapshot captured when the virtual volume became infected (e.g., resulting in less data loss during recovery).

Further, according to embodiments described herein, snapshots created for virtual volumes may be stored at the storage arrays as opposed to storing the snapshots on a secondary site (e.g., a cloud). This may allow for a quick restore of a VM and/or virtual volume/virtual disk. For example, during recovery, a new virtual volume object may be created by cloning a snapshot created for an infected virtual volume that is stored at the storage array. The virtual volume object may be attached to its corresponding VM after creation. Because the snapshot used to create the virtual volume object is stored at the storage array, costs incurred due to data movement, for example from a cloud to the production environment, may be avoided. Additionally, snapshots created for a VM's virtual volume and stored at the storage array may not be visible to a host where the VM is running until recovery operations are initiated for the virtual volume. Limiting visibility of the snapshots may help to reduce vulnerability of the snapshots during an attack.

In certain embodiments, to aid in the selection of a snapshot for recovery of a virtual volume (e.g., either by a user or a virtualization manager configured to manager the VM associated with the compromised virtual volume), the storage array is configured to collect and provide information about different snapshots generated for the virtual volume. Information about the snapshots may include an age of each snapshot, a delta change between a pair of snapshots (e.g., a number of blocks that have been re-written between these two snapshots, a percentage of the virtual disk file that has been rewritten between these two snapshots, etc.), a deduplication ratio between a pair of snapshots, and/or the like. Analyzing the additional information when selecting a recovery point snapshot may provide a quicker way of selecting the recovery point, thereby increasing the efficiency of recovery of the virtual volume.

Accordingly, techniques described herein help to provide continuous data protection and recovery of virtual volumes from ransomware attacks. As such, data protection and recovery is provided at a low granularity. Further, data protection and recovery is efficient given (1) snapshots are taken at a virtual volume level, as opposed to taking a single snapshot for multiple virtual volumes, and (2) snapshots are able to be stored at the storage array, as opposed to a secondary site, thereby allowing for quicker VM/virtual volume restoration.

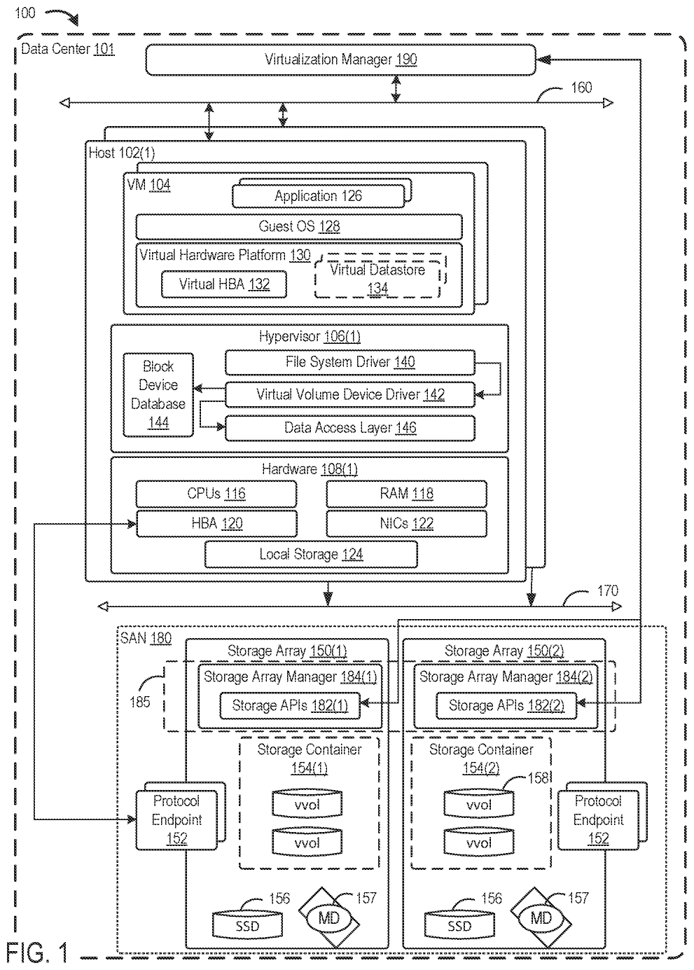

FIG. 1 illustrates example physical and virtual network components in a networking environment 100 in which embodiments described herein may be implemented.

Networking environment 100 includes a data center 101. Data center 101 includes one or more hosts 102, a management network 160, a data network 170, and a virtualization manager 190. Data network 170 and management network 160 may be implemented as separate physical networks or as separate virtual local area networks (VLANs) on the same physical network.

Host(s) 102 may be communicatively connected to data network 170 and management network 160. Data network 170 and management network 160 are also referred to as physical or “underlay” networks, and may be separate physical networks or the same physical network. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 102 may be geographically co-located servers on the same rack or on different racks in any arbitrary location in the data center. Host(s) 102 may be configured to provide a virtualization layer, also referred to as a hypervisor 106, that abstracts processor, memory, storage, and networking resources of a hardware platform 108 into multiple VMs 104.

In certain embodiments, hypervisor 106 may run in conjunction with an operating system (not shown) in host 102. In certain embodiments, hypervisor 106 can be installed as system level software directly on hardware platform 108 of host 102 (often referred to as “bare metal” installation) and be conceptually interposed between the physical hardware and guest operating systems (OSs) 128 executing in the VMs 104. It is noted that the term “operating system,” as used herein, may refer to a hypervisor.

Each of VMs 104 implements a virtual hardware platform that supports the installation of guest OS 128 which is capable of executing one or more applications 126. Guest OS 128 may be a standard, commodity operating system. Examples of a guest OS 128 include Microsoft Windows, Linux, and/or the like. An application 126 may be any software program, such as a word processing program.

In certain embodiments, guest OS 128 includes a native file system layer that interfaces with virtual hardware platform 130 to access, from the perspective of each application 126 (and guest OS 128), a data storage host bus adapter (HBA), which in reality, is a virtual HBA 132 implemented by virtual hardware platform 130 that provides, to guest OS 128, the functionality of disk storage support to enable execution of guest OS 128 as though guest OS 128 is executing on physical system hardware. A virtual disk, as is known in the art, is an abstraction of a physical storage disk that a VM 104 (e.g., an application 126 running in VM 104) accesses via input/output (I/O) operations as though it was a physical disk. A virtual disk file is created for each virtual disk, the virtual disk file being stored in physical storage and storing the data corresponding to the virtual disk.

Host(s) 102 may be constructed on a server grade hardware platform 108, such as an x86 architecture platform. Hardware platform 108 of a host 102 may include components of a computing device such as one or more processors (CPUs) 116, system memory (e.g., random access memory (RAM)) 118, one or more host bus adaptors (HBAs) 120, one or more network interfaces (e.g., network interface cards (NICs) 122), local storage resources 124, and other components (not shown). A CPU 116 is configured to execute instructions, for example, executable instructions that perform one or more operations described herein and that may be stored in the memory and storage system. The network interface(s) enable host 102 to communicate with other devices via a physical network, such as management network 160 and data network 170. Further, the HBA(s) 120 and/or network interface(s) enable host 102 to connect to storage area network (SAN) 180.

Local storage resources 124 may be housed in or directly attached (hereinafter, use of the term “housed” or “housed in” may be used to encompass both housed in or otherwise directly attached) to hosts 102. Local storage resources 124 housed in or otherwise directly attached to the hosts 102 may include combinations of solid state drives (SSDs) 156 or non-volatile memory express (NVMe) drives, magnetic disks (MD) 157, or slower/cheaper SSDs, or other types of storages. Local storage resources 124 of hosts 102 may be leveraged to provide aggregate object-based storage to VMs 104 running on hosts 102. The distributed object-based store may be a SAN 180.

SAN 180 is configured to store virtual disks of VMs 104 as data blocks in a number of physical blocks, each physical block having a physical block address (PBA) that indexes the physical block in storage. An “object” for a specified data block may be created by backing it with physical storage resources of the objected-based storage (e.g., based on a defined policy). Although the example embodiment shown in FIG. 1 illustrates storage as a SAN-based storage system, in some embodiments, the underlying data storage system may be a network attached storage (NAS). For example, instead of using local storage 124 of various hosts, dedicated network accessible storage resources may be used as the storage system.

Architecturally, SAN 180 is a storage system cluster including one or more storage arrays 150 (e.g., storage array 150(1) and storage array 150(2) illustrated in FIG. 1) which may be disk arrays. Storage arrays 150 each have a plurality of data storage units (DSUs) and storage array managers 184 (e.g., storage array manager 184(1) and storage array manager 184(2) illustrated in FIG. 1) that control various operations of storage arrays 150. Storage array managers 184 represent one or more programmed storage processors. In one embodiment, two or more storage arrays 150 may implement a distributed storage array manager 185 that controls the operations of the storage system cluster as if they were a single logical storage system. DSUs represent physical storage units, for example, disk or flash based storage units such as SSDs 156 and/or MDs 157.

According to embodiments described herein, SAN 180 (e.g., the cluster of storage arrays 150(1) and 150(2)) creates and exposes “virtual volumes 158” (vvols 158) to connected hosts 102. In particular, distributed storage array manager 185 or a single storage array manager 184(1) or 184(2) may create vvols 158 (e.g., upon request of a host 102, etc.) from logical “storage containers 154.” Storage containers 154 each represent an abstract entity including one or more vvols 158. In general, a storage container 154 may span more than one storage array 150 and many storage containers 154 may be created by a single storage array manager 184 or a distributed storage array manager 185. Similarly, a single storage array 150 may contain many storage containers 154. Vvols 158 may be logically grouped in the different storage containers 154 based on management and administrative needs. The number of storage containers 154, their capacity (e.g., maximum capacity storage containers 154 may consume), and their size may depend on a vendor-specific implementation. From the perspective of host 102, storage containers 154 are presented as virtual datastores 134 in virtual hardware platforms 130 of each VM 104 on host 102 (e.g., virtual datastores 134 are storage containers 154 in disguise).

Vvols 158, created by SAN 180, are block-based objects of a contiguous range of blocks (e.g., block1, block2, . . . blockN) (e.g., backed by physical DSUs in storage arrays 150(1) and 150(2)). Vvols 158 may be fully represented (e.g., thick provisioned and have a fixed physical size) or may be partially represented (e.g., thinly provisioned) in storage arrays 150. Each vvol 158 has a vvol ID, which is a universally unique identifier that is given to the vvol 158 when the vvol 158 is created. Each created vvol 158 is configured to hold the persistent data (e.g., a virtual disk) for a particular VM. In particular, for a VM 104, a vvol 158 may be created for each virtual disk of the VM 104. In certain embodiments, for each vvol 158, a vvol database (not shown) may store a vvol ID, a container ID of the storage container 154 in which the vvol 158 is created, and an ordered list of <offset, length> values within that storage container 154 that comprise the address space of the vvol 158. The vvol database may be managed and updated by distributed storage array manager 185 or storage array manager(s) 184. In certain other embodiments, a mapping maintained for each vvol 158 and its corresponding physical storage may depend on a vendor-specific implementation.

Each storage array 150 may further implement one or more protocol endpoints 152. In particular, storage arrays 150 implement protocol endpoints 152 as a special type of LUN using known methods for setting up LUNs (e.g., in SAN-based storage systems). As with LUNs, a storage array 150 provides each protocol endpoint 152 a unique identifier (UID), for example, a network addressing authority (NAA) identifier, an extended unique identifier (EUI), a universally unique identifier (UUID), and/or the like in small computer system interface (SCSI) and EUI, a globally unique identification number (GUID), and UUID for NVMe. A protocol endpoint 152 of a storage array 150 acts as a proxy to direct I/Os coming from each host 102 to a correct vvol 158, in a storage container 154, on the storage array 150. Each storage container 154 may have one or more protocol endpoints 152 associated with it.

From the perspective of each application 126 (and guest OS 128), file system calls are initiated by each application 126 to implement file system-related data transfer and control operations (e.g., read and/or write I/Os), such as to their storage virtual disks. The applications 126 may not be aware that the virtual disks are backed by virtual volumes. Such calls are translated by guest OS 128 into disk sector I/O requests that are passed through virtual HBA 132 to hypervisor 106. These requests may be passed through various layers of hypervisor 106 to true hardware HBAs 120 or NICs 122 that connect to SAN 180.

For example, I/Os from applications 126 are received by a file system driver 140 (e.g., different from a virtual machine file system (VMFS) file driver) of hypervisor 106, which converts the I/O requests to block I/Os, and provides the block I/Os to a virtual volume device driver 142 of hypervisor 106. The I/Os received by file system driver 140 from applications 126 may refer to blocks as offsets from a zero-based block device (e.g., vvol 158 is a LUN with a zero-base block range).

When virtual volume device driver 142 receives a block I/O, virtual volume device driver 142 accesses a block device database 144 to reference a mapping between the block device name (e.g., corresponding to a block device instance of a vvol 158 that was created for application 126) specified in the I/O and a protocol endpoint 152 ID (UID of the protocol endpoint 152 LUN) associated with the vvol 158.

In addition to performing the mapping described above, virtual volume device driver 142 issues raw block-level I/Os to data access layer 146 of hypervisor 106. Data access layer 146 is configured to apply command queuing and scheduling policies to the raw block-level I/Os. Further, data access layer 146 is configured to format the raw block-level I/Os in a protocol-compliant format (e.g., SCSI compliant or NVMe compliant for block-based vvols 158) and send them to HBA 120 for forwarding to the protocol endpoint 152. The protocol endpoint 152 then directs the I/O to the correct vvol 158.

In certain embodiments, virtualization manager 190 is a computer program that executes in a server in data center 101, or alternatively, virtualization manager 190 runs in one of VMs 104. Virtualization manager 190 is configured to carry out administrative tasks for the data center 101, including managing hosts 102, managing (e.g., configuring, starting, stopping, suspending, etc.) VMs 104 running within each host 102, provisioning VMs 104, transferring VMs 104 from one host 102 to another host 102, transferring VMs 104 between data centers, transferring application instances between VMs 104 or between hosts 102, and load balancing VMs 104 among hosts 102 within a host cluster. Virtualization manager 190 may carry out such tasks by delegating operations to hosts 102. Virtualization manager 190 takes commands as to creation, migration, and deletion decisions of VMs 104 and application instances on the data center 101. However, virtualization manager 190 also makes independent decisions on management of local VMs 104 and application instances, such as placement of VMs 104 and application instances between hosts 102.

In certain embodiments, storage application programming interfaces (APIs) 182 are implemented at storage array managers 184(2) (e.g., storage API 182(1) implemented at storage array manager 184(1) and storage API 182(2) implemented at storage array manager 184(2)). Storage APIs 182 are a set of APIs that permit storage arrays 150 to integrate with virtualization manager 190 for management functionality. For example, storage APIs 182 allow storage arrays 150, and more specifically storage array managers 184, to communicate with virtualization manager 190, to, for example, provide storage health status, configuration information, capacity, and/or the like. In certain embodiments, as described herein, storage APIs 182 allow storage array managers 184 to communicate metrics about one or more vvols 158 to virtualization manager 190. Further, in certain embodiments, storage APIs 182 allow storage array managers 184 to inform virtualization manager 190 about malware threats to one or more vvols 158. In certain embodiments, as described herein, virtualization manager is configured to raise an alarm in response to receiving a threat warning from a storage array manager 184.

In certain embodiments, data protection features, such as snapshotting, are enabled to provide data protection for VMs, and their corresponding virtual disks (as virtual volumes). A snapshot is a copy of a VM 104's disk file (e.g., vmdk file) at a given point in time. Snapshots provide a change log for the virtual disk and are used to restore the VM 104 to a particular point in time prior to when a failure (e.g., corruption), a system error, and/or a malware attack occurs. For example, advanced ransomware attacks may delete, recreate, and/or change file names thereby rendering the virtual disk useless for an end user. Snapshots help to recover from such attacks by allowing data to be restored to a point in time prior to the infection.

As described above, techniques provided herein allow for snapshot creation of vvols 158 by storage arrays 150 (e.g., automatically without user input. The ability to take finer granularity snapshots allows for data protection at the vvol level. Further, recovery of a single vvol 158 using such snapshots may be more efficient, and less prone to data loss, than recovery of a VM 104 (e.g., using a VM-level snapshot) having multiple vvols 158.

Further, because snapshots may be taken with finer granularity, a snapshot creation frequency for one vvol 158 may be different than a snapshot creation frequency for another vvol 158 (although snapshots for multiple vvols 158 associated with a VM 104 may be taken within a same frequency). Further, the lifetime of snapshots maintained for different vvols 158 may be different. According to aspects described herein, snapshot creation frequency and/or the lifetime of snapshots for a particular vvol 158 may be based on the vvol's susceptibility to attack. For example, AI/ML solutions implemented at storage array 150 for a vvol 158 (and, in some cases, in combination with ransomware threat detection operations performed by hypervisor 106) may be used to determine when a vvol 158 is under attack and increase the snapshot creation frequency for the vvol 158 and/or increase an amount of time snapshots of the vvol 158 are preserved, accordingly.

Though snapshot creation is described herein as being done at the vvol level, snapshots may be created for all vvols 158 of a VM 104 at a time, to thereby provide a snaphot view of VM 104 (e.g., at a VM level).

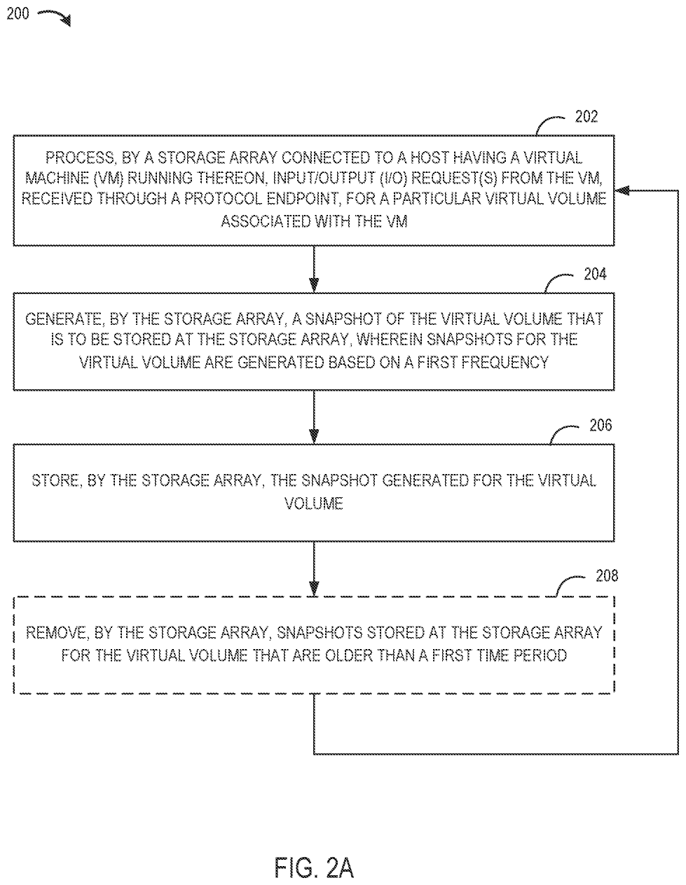

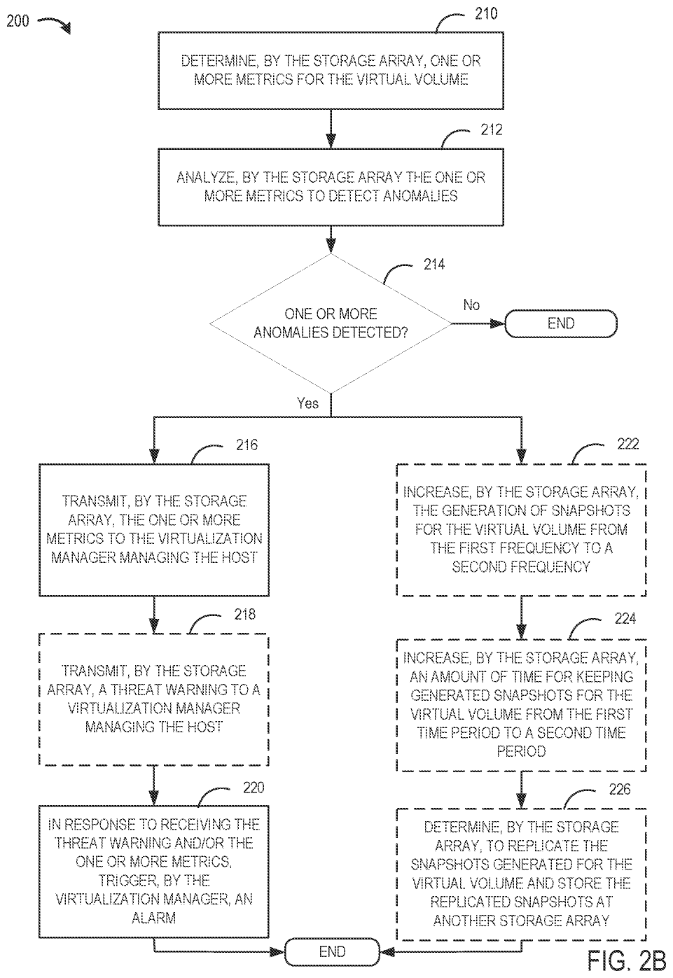

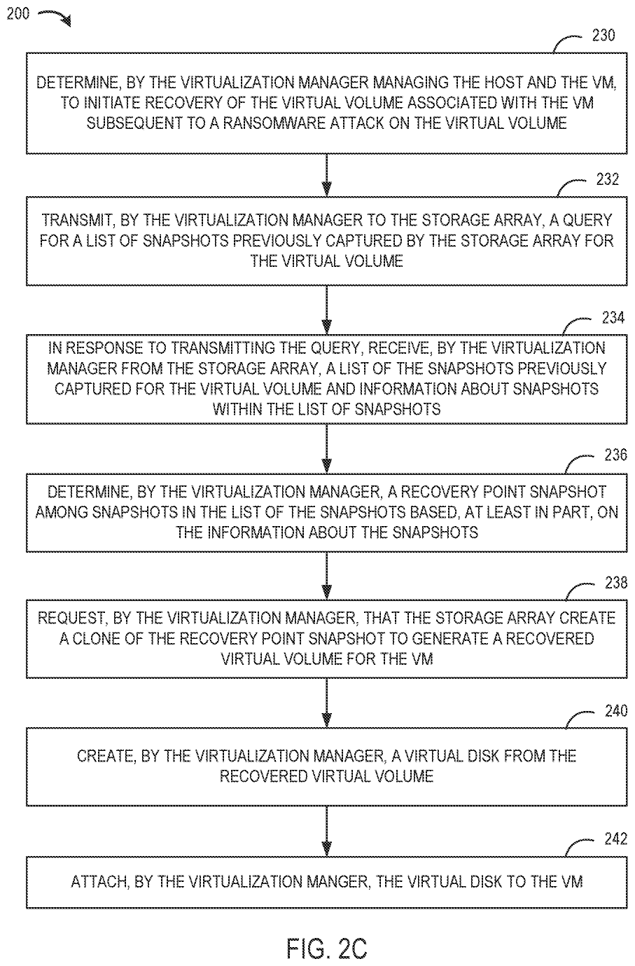

FIG. 2A is a flow diagram illustrating example operations 200 for generating and maintaining snapshots for an example vvol 158, according to an example embodiment of the present disclosure. Further, FIG. 2B is a flow diagram illustrating example operations 200 for ransomware threat detection for the example vvol 158, according to an example embodiment of the present disclosure. Example vvol 158 may be a vvol created for VM 104 on host 102 in FIG. 1. Example vvol 158 may be created from storage container 154(1), where storage container 154(1) is created by storage array manager 184 of storage array 150(1) in FIG. 1. In addition to example vvol 158, two additional vvols may be created and associated with VM 104, such that VM 104 is associated with three vvols 158 (e.g., each encapsulating one of three virtual disks belonging to VM 104).

Operations 200 begin, at operation 202 (e.g., in FIG. 2A), by storage array 150(1), connected to host 102, processing I/O requests from VM 104 directed to example vvol 158. As described above, an application 126 running in VM 104 may issue read and/or write requests to example vvol 158. These requests may be passed from guest OS 128 running in VM 104, to hypervisor 106, to hardware HBAs 120 or NICs 122 that connect to SAN 180, and more specifically storage array 150(1) of SAN 180 where example vvol 158 is stored. The requests may be received by storage array 150(1) for processing from a protocol endpoint 152 of storage array 150(1).

Operations 200 proceed, at operation 204, with generating a snapshot of example vvol 158. Storage array 150(1), and more specifically storage array manager 184(1), may be responsible for generating the snapshot. The snapshot for example vvol 158 may be stored at storage array 150(1) (e.g., as opposed to a cloud or a secondary site). Snapshots for example vvol 158 may be generated based on a first frequency. The frequency of snapshots taken for example vvol 158 may be one snapshot every hour, one snapshot every twenty-four hours (e.g., every day), one snapshot every week, one snapshot every month, etc. For this example, the first frequency may be a frequency selected by a user for all three vvols 158 associated with VM 104. The first frequency may be selected as one snapshot every twenty-four hours. As described in detail below, the snapshot generation frequency may change for one or more of the three vvols 158 based on a determined vulnerability of each vvol 158 to attack.

Operations 200 proceed, at operation 206, with storing the snapshot generated for example vvol 158. The snapshot may be stored in a same storage array 150(1) as example vvol 158). The snapshot may be stored with a time-stamp indicating when the snapshot was taken for example vvol 158. The snapshots corresponding to example vvol 158 may be queried when, for example, example vvol 158 is infected due to a ransomware attack.

Optionally, operations 200 proceed, at operation 208, with removing snapshots stored at storage array 150(1) for example vvol 158 that are older than a first time period. Storage array 150(1), and more specifically storage array manager 184(1), may be responsible for removing snapshots older than the first time period. In particular, snapshots for example vvol 158 may be maintained in storage array 150(1) for (1) a period of time selected by a user and/or (2) a period of time automatically determined by storage array 150(1) based on a risk of example vvol 158 being under attack (e.g., from the perspective of storage array 150(1)). The amount of time a snapshot is maintained for example vvol 158 may be one week, one month, two months, etc. Alternatively, in certain embodiments, snapshots for example vvol 158 are removed based on a number of snapshots for example vvol 158 in storage array 150(1) being greater than a threshold amount of snapshots selected and/or automatically chosen for example vvol 158 (e.g., storage array 150(1) may only keep 100 snapshots for example vvol 158 at a time).

For this example, the first time period may be a time period selected by a user for all three vvols 158 associated with VM 104. The first time period may be selected as one month. As described in detail below, the period for maintaining snapshots in storage array 150(1) may change for one or more of the three vvols 158 based on whether each vvol 158 is predicted to be under attack or not.

Subsequent to operation 206, and in some cases, operation 208, operations 200 proceed back to operation 202 such that storage array 150(1) continues to receive I/O requests for example vvol 158, generate snapshots for example vvol 158 (e.g., based on the first frequency), and remove snapshots for example vvol 158 older than the first time period.

In conjunction with (or subsequent to) operations 202-208 illustrated in FIG. 2A, operations 210-226 may be performed to predict whether example vvol 158 is under attack, and where example vvol 158 is likely under attack, (1) increase the snapshots generated for example vvol 158 in storage array 150(1), (2) increase an amount of snapshots maintained for example vvol 158 in storage array 150(1), and/or (3) clone the snapshots generated for example vvol 158 to a secondary site.

In particular, at operation 210, storage array 150(1), and more specifically, storage array manager 184(1), determines one or more metrics for example vvol 158. Such metrics may include I/O patterns (e.g., patterns of reads and writes) to example vvol 158, IOPS for example vvol 158, data deduplication ratios of data written to example vvol 158, data compression ratios for data written to example vvol 158, and/or the like.

Operations 200 proceed, at operation 212, with storage array 150(1) (e.g., storage array manager 184(1)) analyzing the one or more metrics to detect anomalies. At operation 214, storage array manager 184(1) determines whether one or more anomalies were detected. An anomaly may be a metric which deviated from what is standard, normal, and/or expected for vvols 158 in general, or example vvol 158 specifically. For example, it may be expected that a deduplication ratio of data written to example vvol 158 is between 5-20%. Thus, where the determined deduplication rate of data written to example vvol 158 is less than 5%, storage array manager 184(1) may detect this anomaly. As described above, a low or decreasing data deduplication ratio (e.g., indicating that almost no redundant data is being written to example vvol 158) may indicate that the virtual disk file is at risk of being encrypted by a malicious attacker (e.g., a ransomware attack). Thus, detecting anomalies, such as low or decreasing deduplication ratios for example vvol 158, may provide insight into the risk/likelihood of example vvol 158 being under attack (e.g., in some cases prior to the attack completing).

Where, at operation 214, no anomalies are detected by storage array manager 184(1), storage array manager 184(1) may determine that example vvol 158 is not likely under attack. As such, the first frequency and the first time period for generating and maintaining snapshots for example vvol 158, respectively, may remain unchanged. Further, cloning procedures for example vvol 158 (e.g., do not perform cloning), where performed, may also remain unchanged.

Alternatively, where, at operation 214, one or more anomalies are detected by storage array manager 184(1), operations 200 proceed to operation 216, and in some cases, operation 222.

At operation 216, storage array 150(1), and more specifically storage array manager 184(1), transmits, using storage APIs 182, one or more of the metrics collected for example vvol 158 to virtualization manager 190 connected to storage array 150(1). In certain embodiments, virtualization manager 190 takes action based on the metrics supplied by storage array manager 184(1). For example, virtualization manager 190 may analyze the metrics, determine that vvol 158 is potentially under attack, and trigger an alarm. In certain embodiments, virtualization manager 190 takes action further based on threat detection metrics and/or information supplied by hypervisor 106 on host 102 where VM 104 (e.g., associated with vvol 158) is running.

Optionally at operation 218, storage array manager 184(1) may also transmit a threat warning to virtualization manager 190 based on detecting one or more anomalies in metrics collected for vvol 158 at operations 212 and 214.

At operations 220, virtualization manager 190 is configured to trigger an alarm for vvol 158 in response to receiving (and, in some cases, analyzing) the one or more metrics and/or the threat warning from storage array manager 184(1) at operation 216 and operation 218, respectively.

In addition to operations 216-220, storage array manager 184(1) may optionally perform operations 222-224 to (1) increase the snapshots generated for example vvol 158 in storage array 150(1), (2) increase an amount of snapshots maintained for example vvol 158 in storage array 150(1), and/or (3) clone the snapshots generated for example vvol 158 to a secondary site.

For example, at operation 222, storage array manager 184(1) may increase the frequency of the generation of snapshots for example vvol 158 from the first frequency to the second frequency. In particular, for this example, and not meant to be limiting this particular example, storage array manager 184(1) may increase the frequency of snapshots generated for example vvol 158 from one snapshot taken every twenty-four hours to one snapshot taken every twenty hours, such that snapshots are taken more frequently for example vvol 158.

Alternatively, or in addition to operation 222, at operation 224, storage array manager 184(2) may increase the period of time that snapshots for vvol 158 are maintained in storage array 150(1) from the first time period to a second time period. In particular, for this example, and not meant to be limiting to this particular example, storage array manager 184(1) may increase the time for keeping snapshots for vvol 158 in storage array 150(1) from one month to two months.

Alternatively, or in addition to operations 222 and/or 224, at operation 226, storage array manager 184(2) may clone (or replicate, transfer, etc.) snapshots generated for example vvol 158, and store such cloned (or replicated, transferred, etc.) snapshots at a secondary site. In cases where cloning of snapshots for example vvol 158 was previously occurring, at operation 226, storage array manager 184(2) may determine to increase the frequency of cloning and/or increase the time period for which cloned snapshots for example vvol 158 are maintained on the secondary site.

Subsequent to operation 222, operation 224, and/or operation 226, storage array manager 184(1) may continue operations 200 using the new second frequency and/or second time period. Further, in some cases, where cloning of snapshots for example vvol 158 are initiated at operation 226, storage array manager 184(1) may also generate clones of snapshots for example vvol 158.

As describe above, increasing the frequency, lifetime, and/or cloning of snapshots maintained for example vvol 158 increases the number of snapshots maintained for example vvol 158. As such, should recovery of example vvol 158 be required, for example, as a result of a ransomware attack, a user may select an appropriate recovery point from the multiple snapshots, as opposed to only having a small selection of snapshots to select from. The larger number of snapshots may help to ensure that at least one of the snapshots was taken for the vvol 158 prior to infection of example vvol 158 such that recovery of data can be made from a point in time prior to the attack. Further, the larger number of snapshots may help to decrease data loss during recovery given the time step between a healthy snapshot and an infected snapshot generated for example vvol 158 may be smaller (e.g., due to the increased frequency).

For the above example illustrated in FIGS. 2A and 2B, it may be assumed that at a later time example vvol 158 is compromised, and thus needs to be recovered. Although not meant to be limiting to this particular example, it may be assumed that recovery of example vvol 158 is needed due to encryption of vvol 158, as a result of a ransomware attack.

FIG. 2C is a flow diagram illustrating example operations 200 for recovery of compromised example vvol 158, according to an example embodiment of the present disclosure. Operations 200 illustrated in FIG. 2C may be performed by storage array manager 184(1) (e.g., of storage array 150(1)) and virtualization manager 190 illustrated in FIG. 1.

Operations 200 in FIG. 2C begin, at operation 230, by determining to initiate recovery of example vvol 158. Virtualization manager 190 may make this determination to recover example vvol 158. In making this determination, virtualization manager 190 may earmark another host 102 (e.g., in this case, not host 102 having VM 104, associated with the compromised example vvol 158) in data center 101 for performing recovery operations of compromised example vvol 158 (although in some other cases, host 102 may be selected for performing such recovery operations).

At operation 232, virtualization manager 190 transmits a query, to storage array 150(1), requesting a list of snapshots previously captured, by storage array 150(1), for example vvol 158. These snapshots may be snapshots that are maintained at storage array 150(1). In response to receiving the query, storage array manager 184(1) may collect such snapshots and provide a list of these snapshots to virtualization manager 190. Accordingly, in response to transmitting the query, at operation 234, virtualization manager 190 receives the list of snapshots generated and maintained for vvol 158. In certain embodiments, virtualization manager 190 further receives information about snapshots within the list of snapshots from storage array manager 184(1). Information about the snapshots may include an age of each snapshot, a deduplication ratio of each snapshot, a delta change between a pair of snapshots (e.g., a number of blocks have been re-written between these two snapshots, a percentage of the virtual disk file that has been rewritten between these two snapshots, the change in deduplication rate, etc.), and/or the like.

At operation 236, virtualization manager 190 determines a recovery point snapshot among snapshots in the list of snapshots based, at least in part, on the information about the snapshots received from storage array manager 184(4). In certain embodiments, virtualization manager 190 determines the recovery point snapshot based on input received from a user. For example, virtualization manager 190 may provide the snapshots and additional information about the snapshots to the user, and the user may select the recovery point snapshot based, at least in part, on the information. As an illustrative example, the list of snapshots may contain fifty snapshots. By comparing the deduplication ratio between snapshots numerically ordered in the list of snapshots (e.g., based on their associated timestamps), the user may be able to determine around when example vvol 158 started to become infected. As such, the user may select a snapshot taken for vvol 158 prior in time to when the deduplication ratio began to decrease (e.g., such that example vvol 158 is recovered from a non-infected snapshot). In certain embodiments, virtualization manager 190 may automatically make this determination without user input. Analyzing the additional information provided for each of the snapshots when selecting a snapshot recovery point from a pool of snapshots may provide a quicker way of selecting the recovery point, thereby increasing the efficiency of recovery of example vvol 158.

At operation 238, virtualization manager 190 requests that storage array 150(1) create a clone of the recovery point snapshot for example vvol 158, selected at operation 236. In response to receiving the request, storage array manager 184(1) creates a restored vvol 158 from the recovery point snapshot. Storage array manager 184(1) may inform virtualization manager 190 about the restored vvol 158 when new vvol 158 is successfully created, and virtualization manager 190 may update metadata for the restored vvol 158 maintained by virtualization manager 190.

At operation 240, virtualization manager 190 creates a new virtual disk (e.g., vmdk descriptor) from the recovered vvol 158. Further, at operation 242, virtualization manager 190 attaches the created virtual disk to VM 104 (e.g., previously associated with compromised example vvol 158). After ensuring the integrity of the VM/virtual disk, the virtual disk may be moved into production.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for virtual volume recovery, the method comprising:
determining, by a virtualization manager, to initiate recovery of a compromised virtual volume associated with a virtual machine;
transmitting, by the virtualization manager to a storage array managing the compromised virtual volume, a query requesting a list of snapshots previously captured by the storage array for the compromised virtual volume;
in response to transmitting the query, receiving, by the virtualization manager from the storage array:
the list of the snapshots previously captured by the storage array for the compromised virtual volume, and
information about one or more snapshots in the list of snapshots, wherein for each of the snapshots, the information comprises an indication of at least one change between the snapshot and a previous snapshot;
determining, by the virtualization manager, a recovery point snapshot among snapshots in the list of the snapshots based, at least in part, on the information about the one or more snapshots;
creating, by the storage array, a clone of the recovery point snapshot to generate a recovered virtual volume to replace the compromised virtual volume;
creating, by the virtualization manager, a virtual disk from the recovered virtual volume; and
attaching, by the virtualization manager, the virtual disk to the virtual machine.

2. The method of claim 1, further comprising, prior to determining to initiate the recovery of the compromised virtual volume:
determining, by the storage array, one or more metrics for the compromised virtual volume;
detecting, by the storage array, at least one anomaly in the one or more metrics based on analyzing the one or more metrics against expected metrics for the compromised virtual volume; and
in response to detecting the at least one anomaly, performing, by the storage array, at least one of:
increasing a generation of snapshots in the list of snapshots from a first frequency to a second frequency;
increasing an amount of time for keeping the snapshots in the list of snapshots from a first time period to a second time period; or
replicating snapshots in the list of snapshots to another storage array.

3. The method of claim 2, wherein the one or more metrics comprise at least one of input/output (I/O) patterns, I/O operations per second (IOPS), data depulication ratios, or data compression ratios associated with the compromised virtual volume over a period of time.

4. The method of claim 2, further comprising:
providing, by the storage array to the virtualization manager, the one or more metrics, wherein determining, by the virtualization manager, to initiate the recovery of the compromised virtual volume is based, at least in part, on the one or more metrics.

5. The method of claim 4, wherein:
the one or more metrics comprise data depulication ratios for the compromised virtual volume over a period of time; and
determining, by the virtualization manager, to initiate the recovery of the compromised virtual volume is based on detecting a decrease in the data depulication ratios for the compromised virtual volume over the period of time.

6. The method of claim 1, further comprising:
determining, by the virtualization manager, a likelihood of the compromised virtual volume being under attack,
wherein determining, by the virtualization manager, to initiate the recovery of the compromised virtual volume is based on the determined likelihood of the compromised virtual volume being under attack.

7. The method of claim 1, wherein the snapshots previously captured by the storage array for the compromised virtual volume are stored at the storage array.

8. A system comprising:
a host machine comprising at least one first memory and one or more first processors configured to:
run a hypervisor; and
run a virtual machine;
a storage array comprising one or more storage units configured to store a compromised virtual volume associated with the virtual machine and snapshots previously captured by the storage array for the compromised virtual volume; and
a virtualization manager configured to:
determine to initiate recovery of the compromised virtual volume;
transmit, to the storage array, a query requesting a list of the snapshots previously captured by the storage array for the compromised virtual volume;
in response to transmitting the query, receive, from the storage array:
the list of the snapshots previously captured by the storage array for the compromised virtual volume, and
information about one or more snapshots in the list of snapshots,
wherein for each of the snapshots, the information comprises an indication of at least one change between the snapshot and a previous snapshot;
determine a recovery point snapshot among snapshots in the list of the snapshots based, at least in part, on the information about the one or more snapshots;
wherein the storage array is configured to create a clone of the recovery point snapshot to generate a recovered virtual volume to replace the compromised virtual volume;
create a virtual disk from the recovered virtual volume; and
attach the virtual disk to the virtual machine.

9. The system of claim 8, wherein the storage array is further configured to, prior to determining to initiate the recovery of the compromised virtual volume:
determine one or more metrics for the compromised virtual volume;
detect at least one anomaly in the one or more metrics based on analyzing the one or more metrics against expected metrics for the compromised virtual volume; and
in response to detecting the at least one anomaly, perform at least one of:
increase a generation of snapshots in the list of snapshots from a first frequency to a second frequency;
increase an amount of time for keeping the snapshots in the list of snapshots from a first time period to a second time period; or
replicate snapshots in the list of snapshots to another storage array.

10. The system of claim 9, wherein the one or more metrics comprise at least one of input/output (I/O) patterns, I/O operations per second (IOPS), data depulication ratios, or data compression ratios associated with the compromised virtual volume over a period of time.

11. The system of claim 9, wherein the storage array is further configured to:
provide, to the virtualization manager, the one or more metrics, wherein determining, by the virtualization manager, to initiate the recovery of the compromised virtual volume is based, at least in part, on the one or more metrics.

12. The system of claim 11, wherein:
the one or more metrics comprise data depulication ratios for the compromised virtual volume over a period of time; and
to determine, by the virtualization manager, to initiate the recovery of the compromised virtual volume is based on detecting a decrease in the data depulication ratios for the compromised virtual volume over the period of time.

13. The system of claim 8, wherein the virtualization manager is further configured to:
determine a likelihood of the compromised virtual volume being under attack, wherein to determine, by the virtualization manager, to initiate the recovery of the compromised virtual volume is based on the determined likelihood of the compromised virtual volume being under attack.

14. A non-transitory computer-readable medium comprising instructions that, when executed by one or more processors of a computing system, cause the computing system to perform operations for virtual volume recovery, the operations comprising:
determining, by a virtualization manager, to initiate recovery of a compromised virtual volume associated with a virtual machine;
transmitting, by the virtualization manager to a storage array managing the compromised virtual volume, a query requesting a list of snapshots previously captured by the storage array for the compromised virtual volume;
in response to transmitting the query, receiving, by the virtualization manager from the storage array:
the list of the snapshots previously captured by the storage array for the compromised virtual volume, and
information about one or more snapshots in the list of snapshots, wherein for each of the snapshots, the information comprises an indication of at least one change between the snapshot and a previous snapshot;
determining, by the virtualization manager, a recovery point snapshot among snapshots in the list of the snapshots based, at least in part, on the information about the one or more snapshots;
creating, by the storage array, a clone of the recovery point snapshot to generate a recovered virtual volume to replace the compromised virtual volume;
creating, by the virtualization manager, a virtual disk from the recovered virtual volume; and
attaching, by the virtualization manager, the virtual disk to the virtual machine.

15. The non-transitory computer-readable medium of claim 14, wherein the operations further comprise, prior to determining to initiate the recovery of the compromised virtual volume:
determining, by the storage array, one or more metrics for the compromised virtual volume;
detecting, by the storage array, at least one anomaly in the one or more metrics based on analyzing the one or more metrics against expected metrics for the compromised virtual volume; and
in response to detecting the at least one anomaly, performing, by the storage array, at least one of:
increasing a generation of snapshots in the list of snapshots from a first frequency to a second frequency;
increasing an amount of time for keeping the snapshots in the list of snapshots from a first time period to a second time period; or
replicating snapshots in the list of snapshots to another storage array.

16. The non-transitory computer-readable medium of claim 15, wherein the one or more metrics comprise at least one of input/output (I/O) patterns, I/O operations per second (IOPS), data deduplication ratios, or data compression ratios associated with the compromised virtual volume over a period of time.

17. The non-transitory computer-readable medium of claim 15, wherein the operations further comprise:
providing, by the storage array to the virtualization manager, the one or more metrics, wherein determining, by the virtualization manager, to initiate the recovery of the compromised virtual volume is based, at least in part, on the one or more metrics.

18. The non-transitory computer-readable medium of claim 17, wherein:
the one or more metrics comprise data deduplication ratios for the compromised virtual volume over a period of time; and
determining, by the virtualization manager, to initiate the recovery of the compromised virtual volume is based on detecting a decrease in the data depulication ratios for the compromised virtual volume over the period of time.

19. The non-transitory computer-readable medium of claim 14, wherein the operations further comprise:
determining, by the virtualization manager, a likelihood of the compromised virtual volume being under attack,
wherein determining, by the virtualization manager, to initiate the recovery of the compromised virtual volume is based on the determined likelihood of the compromised virtual volume being under attack.

20. The non-transitory computer-readable medium of claim 14, wherein the snapshots previously captured by the storage array for the compromised virtual volume are stored at the storage array.
